(19) United States
(12) Patent Application Publication
(10) Pub. No.: US 2026/0077601 A1
(43) Pub. Date: Mar. 19, 2026

(54) RECORDING APPARATUS

(71) Applicant: CANON KABUSHIKI KAISHA, Tokyo (JP)

(72) Inventors: TAKAAKI SHIMA, Tokyo (JP); KAZUKI NARUMI, Tokyo (JP); KEI YOSHIZAWA, Tokyo (JP)

(21) Appl. No.: 19/323,412

(22) Filed: Sep. 9, 2025

(30) Foreign Application Priority Data
Sep. 13, 2024 (JP) 2024-159228
Aug. 27, 2025 (JP) 2025-141029

(51) Int. Cl. B41J 2/21; B41J 3/407; B41M 5/00

(52) U.S. Cl. CPC B41J 2/2114; B41J 2/2132; B41J 3/407; B41M 5/0017

(57) ABSTRACT

By controlling the clear ink and clear ink processing liquid application amounts, both image quality performance of the recorded image, including reduced granularity and bleeding, and improved abrasion resistance can be achieved while reducing the amounts of the clear ink and processing liquid used.

### BACKGROUND

### Field of the Technology

The present disclosure relates to a recording apparatus configured to record an image by applying ink.

### Description of the Related Art

In recent years, recording apparatuses that use pigment inks become capable of achieving both excellent color development comparable to dye inks and image fastness, which indicates the strength, long-term storability, and the like of an image, due to advancements in manufacturing technology. As a result, such recording apparatuses are widely used even for public display applications, such as outdoor/point-of-purchase (POP) posters, facility signage, displays, and the like, as well as photographic applications requiring long-term storage of recorded images, and such large-format printing of images requires high productivity. Furthermore, there is an increasing demand for an apparatus for recording on a polyvinyl chloride sheet (hereinafter, referred to as “PVC sheet”) used in coated paper for commercial and publishing printing, such as a printing substrate, wallpaper, tarpaulin, and the like, in order to reduce costs of printing small quantities of a wide variety of items.

There is an inkjet recording method in which a processing liquid that induces aggregation upon reacting with a color ink containing a color material is ejected to a recording medium described above so that the processing liquid reacts with a color ink on the recording medium, thereby improving recording quality. Use of the processing liquid induces aggregation of components in a color ink composition, such as a pigment, and immobilizes the components on the recording medium, thereby making it possible to improve recording quality.

On the other hand, it is known that the aggregation of an ink composition using a processing liquid decreases the smoothness of a coating film, which leads to a decrease in abrasion resistance.

To address such an issue, for example, Japanese Patent Application Laid-Open No. 2008-149514 describes a technology for improving abrasion resistance across all recorded gradations by applying a clear ink in an amount corresponding to the recorded gradations, i.e., the application amounts of color inks.

### SUMMARY

According to embodiments of the present disclosure, a recording apparatus includes a recording unit including a plurality of ejection ports configured to apply a color ink containing a resin particle and a color material, a plurality of ejection ports configured to apply a clear ink containing a resin particle but not containing a color material, and a plurality of ejection ports configured to apply a processing liquid containing a reactive component that reacts with the resin particle and the color material in the color ink and with the resin particle in the clear ink and induces aggregation or gelation; and a determination unit configured to determine an application amount of the color ink, an application amount of the clear ink, and an application amount of the processing liquid that are applied from the recording unit per unit region of a recording medium. The determination unit determines the application amount of the clear ink and the application amount of the processing liquid for at least three gradations each having an application amount ratio of the application amount of the processing liquid to the application amount of the color ink, each application amount ratio being different from each other. The application amount of the clear ink for a second gradation range in which the application amount of the color ink is a second amount and the application amount ratio is a second ratio, is greater than the application amount of the clear ink for a first gradation range in which the application amount of the color ink is a first amount less than the second amount and the application amount ratio is a first ratio less than the second ratio. The application amount of the clear ink for the second gradation range in which the application amount of the color ink is the second amount, is greater than the application amount of the clear ink for a third gradation range in which the application amount of the color ink is a third amount greater than the second amount and the application amount ratio is a third ratio less than the second ratio.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are a perspective view and a cross-sectional view illustrating configurations of an inkjet recording apparatus according to a first embodiment.

FIG. 2 is a schematic diagram illustrating a recording head according to the first embodiment viewed from an ejection port side.

FIG. 3 is a schematic diagram illustrating a recording control system according to the first embodiment.

FIG. 4 is a flowchart illustrating an image data processing procedure according to the first embodiment.

FIG. 5A is a diagram illustrating a table that stores the relationship between color ink and processing liquid application amounts according to the first embodiment. FIG. 5B is a diagram illustrating the relationship between the color ink application amount and the ratio of the processing liquid application amount to the color ink application amount according to the first embodiment.

FIG. 6A is a diagram illustrating a table that stores the relationship between color ink and clear ink application amounts according to the first embodiment. FIG. 6B is a diagram illustrating the relationship between the color ink application amount and the ratio of the total processing liquid application amount, which is the sum of color ink processing liquid and clear ink processing liquid application amounts, to the total ink application amount, which is the sum of color ink and clear ink application amounts, according to the first embodiment.

FIG. 7 is a diagram illustrating image data used in a second embodiment.

FIG. 8A is a flowchart illustrating an image data processing procedure according to the second embodiment. FIG. 8B is a flowchart illustrating an image data processing procedure according to the second embodiment.

FIG. 9A is a diagram illustrating a table that stores the relationship between color ink and clear ink application amounts according to a third embodiment. FIG. 9B is a diagram illustrating the relationship between the color ink application amount and the ratio of the total processing liquid application amount, which is the sum of color ink processing liquid and clear ink processing liquid application amounts, to the total ink application amount, which is the sum of color ink and clear ink application amounts, according to the third embodiment.

### DESCRIPTION OF THE EMBODIMENTS

### First Embodiment

A recording apparatus that uses an inkjet recording method will be described below as an example. The recording apparatus may be a single function printer including only, for example, a recording function, or may be a multi-function printer including a plurality of functions, such as a recording function, a fax function, and a scanner function. Further, the recording apparatus may be a manufacturing apparatus that manufactures a color filter, an electronic device, an optical device, a microstructure, or the like using a predetermined recording method.

It can be noted that, in the following description, the term “recording” is not limited to a case where intentional information, such as text or drawing, is formed, and refers to the recording of information, whether intentional or unintentional. Furthermore, the term refers to a wide range of cases, such as a case where an image, design, pattern, structure, or the like is formed on a recording medium, or a case where a medium is processed, regardless of whether it is something visualized so that a human can visually perceive.

Further, the term “recording medium” refers to not only paper used in a common recording apparatus but also other ink-receptive media, such as a cloth, plastic film, metal plate, glass, ceramics, resin, wood, or leather. Further, examples of non-absorbent recording media include recording media that are not prepared as recording media for aqueous inkjet ink, such as glass, plastic, film, or Yupo. Further, examples include recording media that have not undergone surface treatment for inkjet printing (i.e., recording media without an ink-absorbing layer), such as a plastic film or a substrate, such as paper, coated with plastic. Examples of plastics include polyvinyl chloride, polyethylene terephthalate, polycarbonate, polystyrene, polyurethane, polyethylene, and polypropylene. Further, specific examples of low-absorbency recording media include recording media such as printing substrates used in offset printing, such as art paper or coated paper.

A Bristow method is a publicly-known method for evaluating ink permeability into a recording medium. A detailed description thereof is omitted. However, an outline is provided below.

A predetermined amount of ink is injected into a retention container having an opening slit of a predetermined size. The injected ink is brought into contact with a recording medium, which has been processed into a strip and wound around a disk, through the slit. With the position of the retention container being fixed, the disk is rotated, and the area (length) of the ink band transferred onto the recording medium is measured.

A transfer amount (ml/m2) per unit area can be calculated based on the area of the ink band. This transfer amount (ml/m2) indicates the volume of ink absorbed into the recording medium over a predetermined time. The predetermined time herein is defined as a transfer time. The transfer time (millisecond\hat{ }1/2) corresponds to the contact time between the slit and the recording medium and is calculated from the speed of the disk and the width of the opening slit.

The amount of aqueous ink transferred into common coated printing paper was measured using the Bristow method, and the transfer amount in 1-second was 20 ml/m2 or less. While specialized inkjet paper typically exhibits a transfer amount of 30 ml/m2 or more as determined by the Bristow method, some recording media exhibit a transfer amount of 20 ml/m2 or less. Such recording media are specialized inkjet paper but can be referred to as low-absorbency recording media. In other words, an effect is produced not only by applying the configuration to coated printing paper but also to a common recording medium that has low absorbency.

### Overall Configuration

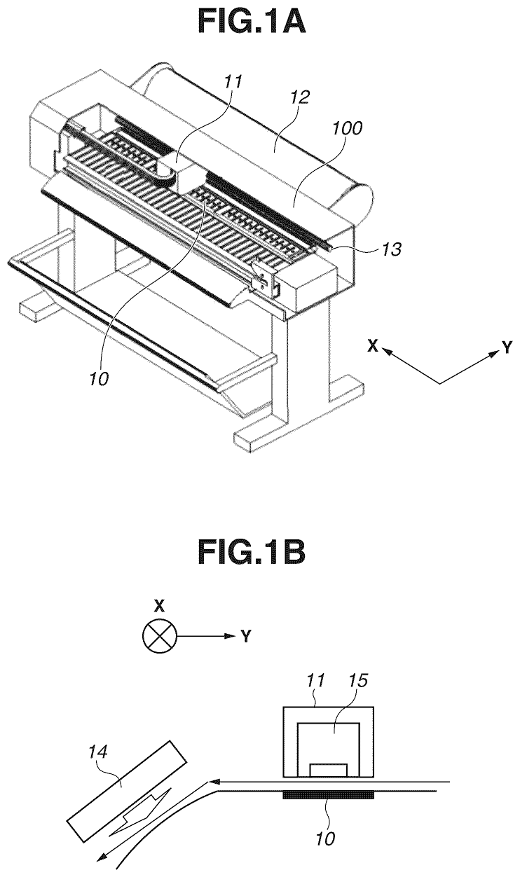

FIG. 1A is a partially exploded perspective view illustrating an internal mechanism of an inkjet recording apparatus 100 according to the present embodiment, and FIG. 1B is a cross-sectional view. As illustrated in FIG. 1A, a recording medium 12 is conveyed in a −Y direction in FIG. 1A as a sub-scanning motor (not illustrated) is driven.

Further, a guide shaft 13 is disposed to extend in an X direction intersecting the conveyance direction of the recording medium 12. A carriage 11 on which a recording head 15 is mounted is disposed to face a platen 10, and while being supported by the guide shaft 13, the carriage 11 reciprocates (performs reciprocating scanning) along an X-axis in FIGS. 1A and 1B as a main scanning motor (not illustrated) is driven. While the carriage 11 moves and scans, the recording head 15 mounted on the carriage 11 ejects ink onto the recording medium 12 based on recording data, thereby performing recording on the recording medium 12.

The inkjet recording apparatus 100 according to the present embodiment uses a so-called bidirectional recording method in which the recording head 15 performs recording on a recording medium by ejecting ink during the forward and backward passes. When the recording head 15 performs a scan involving a single recording operation, the recording medium 12 is conveyed by a predetermined amount by the sub-scanning motor (not illustrated). The main scanning speed is variable, and a scan can be performed at 10 inches to 70 inches per second.

The recording resolution is also variable, and an ejection operation can be performed at 300 dpi to 2400 dpi. After the above-described scan, the recording medium 12 is conveyed, and subsequently, recording is performed on the next band width.

In a case where a recording operation command is input from a host computer (external apparatus) connected externally, the recording medium 12 is fed to a position where recording can be performed by the recording head 15 mounted on the carriage 11. Subsequently, the main scanning of the recording head 15 while ejecting ink based on a recording signal and the conveyance operation of the recording medium 12 by the predetermined amount are repeated alternately, thereby forming an image. Subsequently, the image formed on the recording medium 12 is conveyed along the conveyance direction on the platen 10, and a heating mechanism 14 including a hot air fan blows hot air to heat the recording medium to 100° C., thereby heating and fixing the image. This heating unit also includes a function that heats water-soluble resin particles, which will be described below, to form a coating in the inkjet recording apparatus 100. The water-soluble resin particles are heated after being applied to the recording medium 12 to form a film so that the abrasion resistance of the image is enhanced.

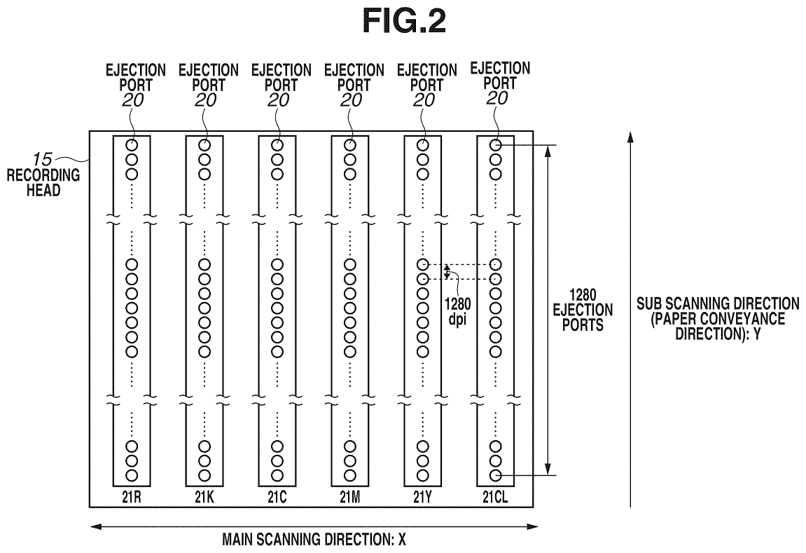

The recording head 15 will be described in detail. In the recording head 15, 1280 ejection ports 20 are aligned for each color with a density of 1200 ejection ports per inch along the Y direction as illustrated in FIG. 2, thereby forming an ejection port column for each color. FIG. 2 is a diagram illustrating a configuration of the recording head 15 viewed from an ejection port surface. According to the first embodiment, six ejection port column formation substrates are mounted, and each ejection port column formation substrate includes a processing liquid ejection port column 21R, a black ejection port column 21K, a cyan ejection port column 21C, a magenta ejection port column 21M, a yellow ejection port column 21Y, and a clear ink ejection port column 21CL. According to the present embodiment, a clear ink and a processing liquid are included in addition to color inks. The clear ink contains fine resin particles but does not contain a color material. The processing liquid contains a reagent and reacts with solid content, such as a color material or fine resin particles, contained in each ink to promote aggregation of the solid content. Details of each ink will be described below.

Each ejection port 20 ejects approximately 4.5 pl of ink. However, this is not intended to be limiting, and the ejection amounts may be set differently for the color inks, the processing liquid, and the clear ink, or the ejection amounts may vary among the individual color inks. The recording head 15 ejects ink from the ejection ports 20 using an ejection energy generation unit, such as an electrothermal converting member (heater) and a piezoelectric element. In a case where an electrothermal converting member is used, the electrothermal converting member generates heat to cause water in the inks to generate bubbles, and the inks can be ejected using this bubble generating energy. Further, the ejection port columns do not necessarily have to be formed in the same recording head and may be separated. Each ejection port column is connected to an ink tank (not illustrated) storing the corresponding ink to supply the inks. It may be noted that the recording head 15 and the ink tanks used in the present embodiment may be configured either integrally or as individually separable components.

During image recording, while the carriage 11 is moved along the X direction, the recording operation in which the recording head 15 ejects ink and the conveyance operation in which the recording medium 12 is conveyed in the conveyance direction by the predetermined amount are repeated. Furthermore, a multi-pass recording method, i.e., a recording method in which the recording head 15 performs recording by scanning a certain region on a recording medium a plurality of times, may be employed. By employing such multi-pass recording, even in a case where there are variations in ejection characteristics of the ejection ports and/or in the conveyance amount of the recording medium, these variations are distributed across the entire recorded image, thereby making the variations less visible.

In the case of the present embodiment, while the recording head 15 is moved along the X direction, a forward scan is performed to apply the processing liquid, the black ink, the cyan ink, the magenta ink, the yellow ink, and the clear ink in this order to a recording medium, thereby recording an image corresponding to a single scan. In a case where a unidirectional recording method is employed, the recording medium 12 is subsequently conveyed by the predetermined amount, and the recording head 15 is moved in the −X direction and returned to the original home position. Subsequently, a forward scan is performed again to record an image corresponding to the next single scan. On the other hand, in a case where bidirectional recording is employed, the recording medium 12 is conveyed by the predetermined amount after the forward scan, and while the recording head 15 is moved along the −X direction specified by an arrow X, the inks are ejected. In other words, the clear ink, the yellow ink, the magenta ink, the cyan ink, the black ink, and the processing liquid are applied in this order to the recording medium (a backward scan is preformed), thereby recording an image corresponding to the next single scan. The processing liquid is applied to the recording medium prior to the color inks and the clear ink, thereby fully demonstrating its performance. During a backward scan of the recording head 15, since the processing liquid is applied to the recording medium after the color inks and the clear ink, the function of the processing liquid may not be fully demonstrated. This is particularly not desirable to occur in a case of a single-pass recording method in which the recording head 15 performs recording by scanning once in a certain region on a recording medium. In multi-pass recording in which recording is performed by scanning a certain region on a recording medium twice or more, the processing liquid may be applied during the first scan, so that even in a case where the bidirectional recording method is employed, the performance of the processing liquid can be fully demonstrated. Particularly in multi-pass recording processing liquid, applying the clear ink in later scans enables the performance of the clear ink to be more fully demonstrated.

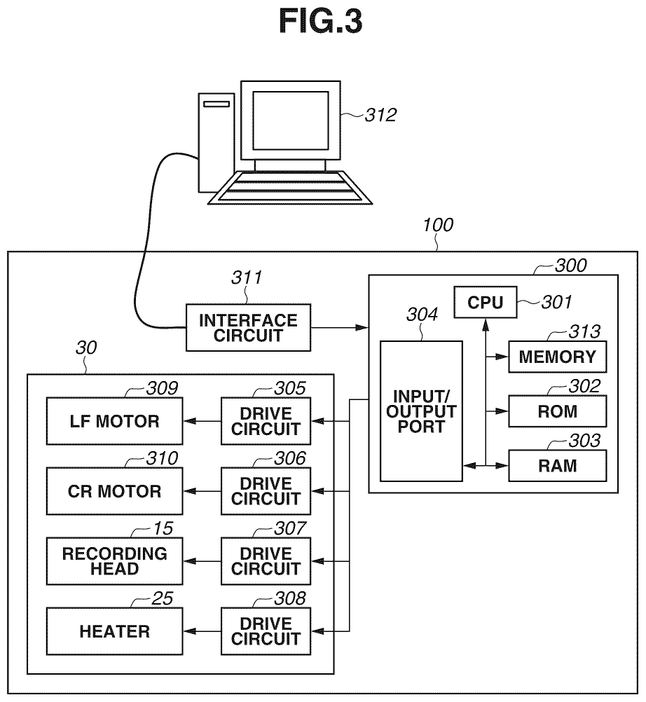

In a block configuration diagram in FIG. 3 illustrating a control system of the inkjet recording apparatus 100, an image input unit (interface) 311 inputs various types of image data. Examples of that image data include multivalued image data from an image input device such as a scanner or digital camera, multivalued image data stored in various recording media such as a hard disk, and the like. An image processing unit 300 performs image processing, which will be described below, thereby converting multivalued image data input by the image input unit 311 into binary image data. This binary image data includes image data for the black ink, the cyan ink, the magenta ink, the yellow ink, the clear ink, and the processing liquid. A central processing unit (CPU) 301 controls each component of the inkjet recording apparatus 100. A read-only memory (ROM) 302 stores programs, such as a control program and an error processing program, executed by the CPU 301. A random access memory (RAM) 303 temporarily stores various types of data (such as image data and a recording signal fed to the recording head 15). A gate array 304 controls the supply of image data to the recording head 15 and also controls the data transfer between the image input unit 311 and the CPU 301 and the RAM 303.

An image output unit 30 receives input binary image data converted by the image processing unit 300 and performs image recording. A main scanning motor (carriage return (CR) motor) 310 is configured to move the recording head 15, and a line feed (LF) motor 309 is configured to convey the recording medium 12. Motor drivers 305 and 306 are configured to drive the LF motor 309 and the CR motor 310, respectively. A head driver 307 is configured to drive the recording head 15. A recording signal input via the image input unit 311 is converted into binary image data by the gate array 304 and the CPU 301. Subsequently, the LF motor 309 and the CR motor 310 are driven by the motor drivers 305 and 306, and the recording head 15 is driven based on binary recording data transmitted to the head driver 307, thereby recording an image.

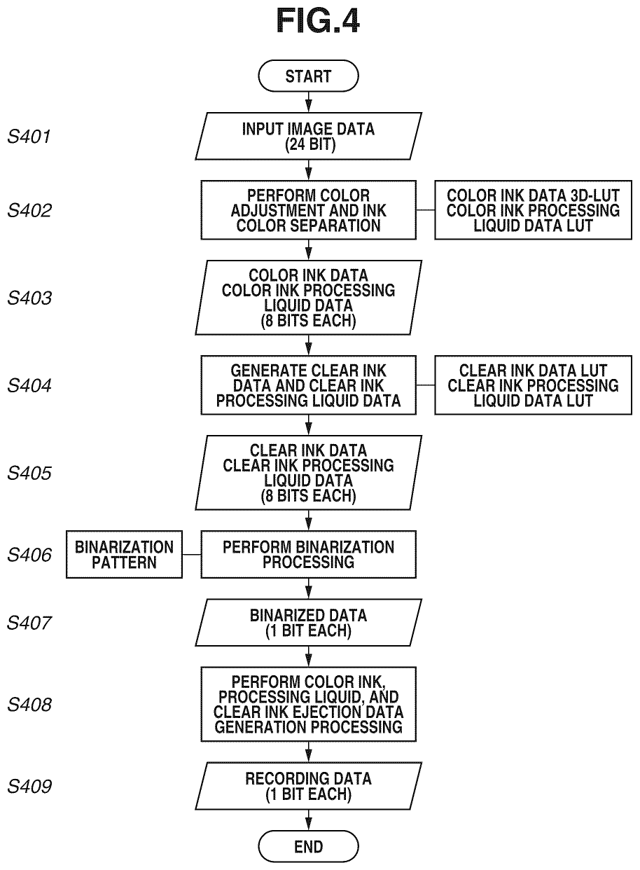

FIG. 4 is a flowchart illustrating the image processing performed by the image processing unit 300.

In FIG. 4, each rectangular-shaped block represents an image processing step, and each parallelogram-shaped block represents data.

First, in step S401, multivalued input image data in red, green, and blue (RGB) format is input from the image input unit 31. In step S402, an ink color separation processing unit performs ink color separation processing on the input image data, thereby converting the input image data into multivalued color ink data corresponding to the plurality of types of color inks (C, M, Y, K) used for image recording. Specifically, while a color conversion lookup table (a three-dimensional (3D) lookup table (LUT) (3D-LUT)) is referred to, the image data input in step S401 is converted, for each predetermined region, into multi-gradation data (color ink data) corresponding to the plurality of ink colors that can be used in the inkjet inkjet recording apparatus 100. Furthermore, the application amount of the color ink processing liquid is determined based on the sum of color inks per pixel, and the data is converted into 8-bit image data corresponding to the application amount. Details of the data generation for the color ink processing liquid will be described below. The number of dimensions of the lookup table indicates the number of components of the input image data. In the present embodiment, since the input image data includes three components R, G, and B, the 3D-LUT is used. In step S403, the generated cyan (C), magenta (M), yellow (Y), and black (K) (CMYK) data is, for example, 8-bit data having a gradation level of approximately 256 levels and has a resolution of 600 dpi at this point. To realize a 2400 dpi×1200 dpi recording mode, the inkjet recording apparatus 100 performs tone representation for each 4×2 recording region consisting of four pixels in the X-direction and two pixels in the Y-direction. In other words, tone representation is performed for each unit region (unit area) corresponding to a resolution of 600 ppi×600 ppi. Recording duty will be described. The recording duty is an indicator of how many dots (the number of dots) each sized to fully occupy a single pixel are formed within the single pixel in a case where, for example, a unit region corresponding to a resolution of 1200 dpi×1200 dpi is defined as the single pixel. A 100% recording duty indicates a state where one dot is formed per pixel.

In step S404, a process of generating clear ink data and clear ink processing liquid data is performed, and each application amount is set based on a table that stores, for each type of recording media, the relationship between the application amounts of the clear ink and the clear ink processing liquid and the application amounts of the color inks. Then, 8-bit image data corresponding to the set application amounts is generated.

In step S406, a binarization processing unit performs binarization processing, thereby developing the multivalued CMYK data and the CMYK processing liquid data for the individual inks, the clear ink data, and the clear ink processing liquid data into binary bitmap data of the individual inks and the processing liquid for the individual inks, based on a binarization pattern stored in a binarization pattern storage unit. Consequently, binary image data for applying the plurality of types of inks (C, M, Y, K), the clear ink, and the processing liquid is generated.

In step S408, a process of generating color ink ejection data, processing liquid ejection data, and clear ink ejection data is performed, thereby generating binary recording data for driving the recording head 15 based on the image data generated in step S403 and the image data generated in step S405.

### Ink Compositions

Next, compositions of the inks and a water-soluble resin particle-containing ink used in the present embodiment will be described. Unless otherwise specified, “parts” and “%” in the following description are by mass.

### 1. Composition of Each Ink

A composition of each ink will be described in detail.

The color inks (K, C, M, Y), the clear ink, and the processing liquid (RCT) used in the present embodiment each contain a water-soluble organic solvent. The water-soluble organic solvent can have a boiling point higher than or equal to 150° C. and lower than or equal to 300° C., due to the wettability and moisture retention of a port face of the recording head 15. Further, from the perspective of the function of a film-forming additive with respect to resin particles and the swelling and solubility with respect to a recording medium including a resin layer, in particular, a ketone compound such as acetone or cyclohexanone, an ethylene glycol derivative such as tetraethylene glycol dimethyl ether, a heterocyclic compound having a lactam structure such as N-methyl-pyrrolidone or 2-pyrrolidone, or the like can be used. From the perspective of ejection performance, the water-soluble organic solvent content can be 3% by weight or more and 30% by weight or less.

Specific examples of water-soluble organic solvents include alkyl alcohols having 1 to 4 carbon atoms, such as methyl alcohol, ethyl alcohol, n-propyl alcohol, isopropyl alcohol, n-butyl alcohol, sec-butyl alcohol, and tert-butyl alcohol, amides, such as dimethylformamide and dimethylacetamide, ketone or keto alcohols, such as acetone and diacetone alcohol, ethers, such as tetrahydrofuran and dioxane, polyalkylene glycols, such as polyethylene glycol and polypropylene glycol, alkylene glycols containing alkylene groups having 2 to 6 carbon atoms, such as ethylene glycol, propylene glycol, butylene glycol, triethylene glycol, 1,2,6-hexanetriol, thiodiglycol, hexylene glycol, and diethylene glycol, lower alkyl ether acetates, such as polyethylene glycol monomethyl ether acetate, glycerin, lower alkyl ethers of polyhydric alcohols, such as ethylene glycol monomethyl (or ethyl) ether, diethylene glycol methyl (or ethyl) ether, and triethylene glycol monomethyl (or ethyl) ether, polyhydric alcohols, such as trimethylolpropane and trimethylolethane, N-methyl-2-pyrrolidone, 2-pyrrolidone, and 1,3-dimethyl-2-imidazolidinone. The foregoing water-soluble organic solvents can be used either alone or as a mixture. Further, deionized water can be used as water. It can be noted that the water-soluble organic solvent content in each processing liquid (RCT) is not particularly limited, and in order to achieve desired physical property values, an antifoaming agent, a preservative, an anti-mold agent, or the like may also be added to the color material inks (K, C, M, Y) as needed, in addition to the above-described components.

Further, the color inks (K, C, M, Y), the clear ink, and the processing liquid (RCT) used in the present embodiment each contain a surfactant. The surfactant is used to enhance the wettability and spreading performance of the inks on a recording medium. The greater the amount of surfactant added, the stronger the ability to reduce the surface tension of the inks, thereby enhancing the wettability and spreading performance of the inks on a recording medium. In the present embodiment, a small amount of acetylene glycol ethylene oxide (acetylene glycol EO) adduct was added as a surfactant to make adjustments so that each ink had a static surface tension of 30 dyn/cm or less and, furthermore, the difference between the static surface tensions of the color material inks was 2 dyn/cm or less. More specifically, each color material ink was adjusted to have a static surface tension of approximately 22 dyn/cm to 24 dyn/cm. A fully-automatic surface tensiometer CBVP-Z (manufactured by KYOWA KAIMEN KAGAKU KABUSHIKI KAISHA) was used to measure the static surface tensions of the inks. It can be noted that the above-described example of a measuring instrument is not intended to be limiting, and any measuring instrument capable of measuring the static surface tensions of the inks may be used.

Further, the pH levels of all the color material inks in the present embodiment are stable on the alkaline side, and the pH values are 8.5 to 9.5. From the perspective of preventing issues such as elution and degradation of components that come into contact with the color material inks in the inkjet recording apparatus 100 and the recording head 15, and a decrease in the solubility of the dispersed resin in the color material inks, each color material ink can have a pH value greater than or equal to 7.0 and less than or equal to 10.0. A pH METER model number F-52 manufactured by KABUSHIKI KAISHA HORIBA SEISAKUSHO was used to measure the pH values. It can be noted that the above-described example of a measuring instrument is not intended to be limiting, and any measuring instrument capable of measuring the pH values of the inks may be used.

### 2. Water-Soluble Resin Emulsion

The color inks and the clear ink used in the present embodiment each contain a water-soluble resin emulsion.

The term “water-soluble resin emulsion” in the present embodiment refers to fine polymer particles existing in a dispersed state in water. Specific examples include acrylic resin particles synthesized through emulsion polymerization of monomers such as (meth)acrylic acid alkyl ester or (meth)acrylic acid alkylamide monomers, styrene-acrylic resin particles synthesized through emulsion polymerization of monomers such as (meth)acrylic acid alkyl ester or (meth)acrylic acid alkylamide monomers with styrene monomers, polyethylene resin particles, polypropylene resin particles, polyurethane resin particles, styrene-butadiene resin particles, and the like. Further, other resin particles such as core-shell resin particles composed of core and shell portions having different polymer compositions, resin particles obtained by pre-synthesizing fine acrylic particles for particle size control and carrying out emulsion polymerization around the pre-synthesized fine acrylic particles used as seed particles, or the like may also be used. Furthermore, other resin particles such as hybrid resin particles obtained by chemically bonding different resin particles, such as acrylic resin particles and urethane resin particles, may also be used.

### 3. Slip Agent

The color inks and the clear ink used in the present embodiment each contain a slip agent.

The term “slip agent” in the present embodiment refers to wax particles or silicone oil.

Specific examples of wax particles include synthetic wax particles, such as Fischer-Tropsch wax (EMUSTAR-6315) manufactured by NIPPON SEIRO KABUSHIKI KAISHA and polyolefin wax (HI-TECH E-9500) manufactured by TOHO KAGAKU KOGYO KABUSHIKI KAISHA, natural wax particles, such as Carnauba wax (Cerosol 524) manufactured by CHUKYO YUSHI KABUSHIKI KAISHA and paraffin wax (AQUACER497) manufactured by BIKKUKEMI JAPAN KABUSHIKI KAISHA, and the like. Further, silicone oil may be used as a slip agent, and examples include polyether-modified silicone (BYK 333) manufactured by BIKKUKEMI JAPAN KABUSHIKI KAISHA.

### 4. Reagent

In the present embodiment, a system in which recording is performed using a processing liquid to insolubilize some or all of solid components of the color inks and the clear ink is employed as needed to solve image issues such as bleed and beading.

Since the purpose is to insolubilize dissolved dyes, dispersed pigments, and resins, examples of reagents for the processing liquid include polyvalent metal ions (e.g., magnesium sulfate, magnesium nitrate, magnesium chloride, emulsified calcium, aluminum sulfate, iron chloride, or the like). As a type of an aggregation action using such cations, a system that uses a low molecular weight cationic polymer coagulant for charge neutralization of water-soluble resin emulsions and insolubilization of anionic soluble substances may be used.

Another reaction system is an insolubilization system that employs a processing liquid utilizing a pH difference.

As described above, most color inks used for inkjet recording are generally stable on the alkaline side due to the properties and the like of color materials of the color inks, and their pH values are generally greater than or equal to 7.0 and less than or equal to 10.0. From an industrial standpoint and with consideration for external environmental factors and the like, each pH value is primarily set in the vicinity of 8.5 to 9.5 in many cases. To aggregate/solidify the color inks in such a system, an acidic solution is added to change the pH so that destabilization is induced, thereby causing dispersed components to aggregate. In order to achieve such an effect, a solution that is acidic may be used as a processing liquid.

Methods for preparing the inks and processing liquid will be described below.

### Preparation of Resin Particle Dispersion Liquid

First, while a resin particle dispersion liquid used in the first embodiment was heated to 70° C. and agitated under a nitrogen atmosphere, three additive solutions specified below were gradually added dropwise, and polymerization was carried out for five hours. The additive solutions are a mixed solution containing hydrophobic monomers including 28.5 parts methyl methacrylate, a mixed solution containing hydrophilic monomers including 4.3 parts sodium p-styrenesulfonate and 30 parts water, and a mixed solution containing a polymerization initiator including 0.05 parts potassium persulfate and 30 parts water. As a result, 20% by mass of resin particle dispersion liquid was obtained.

### Black Ink

### (1) Dispersion Liquid Preparation

First, an anionic polymer P-1 [styrene/butyl acrylate/acrylic acid copolymer (polymerization ratio (weight ratio)=30/40/30), acid value 202, weight-average molecular weight 6500] was prepared. This anionic polymer P-1 was neutralized with an aqueous solution of potassium hydroxide, followed by dilution with deionized water, thereby preparing 10% by mass of homogeneous aqueous polymer solution.

Six hundred grams of the polymer solution, 100 g of carbon black, and 300 g of deionized water were mixed and mechanically agitated for a predetermined time, followed by centrifugal separation to remove undispersed substances including coarse particles, thereby obtaining a black dispersion liquid. The obtained black dispersion liquid had a pigment concentration of 10% by mass.

### (2) Ink Preparation

To prepare an ink, the black dispersion liquid was used, and components specified below were added to adjust the black dispersion liquid to a predetermined concentration. Subsequently, these components were sufficiently mixed and agitated, followed by pressure filtration using a microfilter (manufactured by FUJI FILM KABUSHIKI KAISHA) having a pore size of 2.5 μm, thereby preparing a pigment ink having a pigment concentration of 2% by mass.
The black dispersion liquid 20 parts,
The resin particle dispersion liquid 40 parts,
Wax particles 3 parts,
Zonyl FSO-100 (fluorinated surfactant manufactured by DuPont) 0.05 parts,
2-Methyl-1,3-propanediol 15 parts,
2-Pyrrolidone 5 parts,
Acetylene glycol ethylene oxide (acetylene glycol EO) adduct (manufactured by KAWAKEN FINE CHEMICALS KABUSHIKI KAISHA) 0.5 parts,
Deionized water balance.

### Cyan Ink

### (1) Dispersion Liquid Preparation

First, an AB type block polymer with an acid value of 250 and a number-average molecular weight of 3000 was prepared by a standard method using benzyl acrylate and methacrylic acid as raw materials. This AB type block polymer was neutralized with an aqueous solution of potassium hydroxide, followed by dilution with deionized water, thereby preparing 50% by mass of homogeneous aqueous polymer solution.

Two hundred grams of the polymer solution, 100 g of C.I. Pigment Blue 15:3, and 700 g of deionized water were mixed and mechanically agitated for a predetermined time, followed by centrifugal separation to remove undispersed substances including coarse particles, thereby obtaining a cyan dispersion liquid. The obtained cyan dispersion liquid had a pigment concentration of 10% by mass.

### (2) Ink Preparation

To prepare an ink, the cyan dispersion liquid was used, and components specified below were added to adjust the cyan dispersion liquid to a predetermined concentration. Subsequently, these components were sufficiently mixed and agitated, followed by pressure filtration using a microfilter (manufactured by FUJI FILM KABUSHIKI KAISHA) having a pore size of 2.5 μm, thereby preparing a pigment ink having a pigment concentration of 2% by mass.
The cyan dispersion liquid 20 parts,
The resin particle dispersion liquid 40 parts,
Wax particles 3 parts,
Zonyl FSO-100 (fluorinated surfactant manufactured by DuPont) 0.05 parts,
2-Methyl-1,3-propanediol 15 parts,
2-Pyrrolidone 5 parts,
Acetylene glycol (EO) adduct (manufactured by KAWAKEN FINE CHEMICALS KABUSHIKI KAISHA) 0.5 parts,
Deionized Water Balance.

### Magenta Ink

### (1) Dispersion Liquid Preparation

First, an AB type block polymer with an acid value of 300 and a number-average molecular weight of 2500 was prepared by a standard method using benzyl acrylate and methacrylic acid as raw materials. This AB type block polymer was neutralized with an aqueous solution of potassium hydroxide, followed by dilution with deionized water, thereby preparing 50% by mass of homogeneous aqueous polymer solution.

One hundred grams of the polymer solution, 100 g of C.I. Pigment Red 122, and 800 g of deionized water were mixed and mechanically agitated for a predetermined time, followed by centrifugal separation to remove undispersed substances including coarse particles, thereby obtaining a magenta dispersion liquid. The obtained magenta dispersion liquid had a pigment concentration of 10% by mass.

### (2) Ink Preparation

To prepare an ink, the magenta dispersion liquid was used, and components specified below were added to adjust the magenta dispersion liquid to a predetermined concentration. Subsequently, these components were sufficiently mixed and agitated, followed by pressure filtration using a microfilter (manufactured by FUJI FILM KABUSHIKI KAISHA) having a pore size of 2.5 μm, thereby preparing a pigment ink having a concentration of 3% by mass.
The magenta dispersion liquid 30 parts,
The resin particle dispersion liquid 40 parts,
Wax particles 3 parts,
Zonyl FSO-100 (fluorinated surfactant manufactured by DuPont) 0.05 parts,
2-Methyl-1,3-propanediol 15 parts,
2-Pyrrolidone 5 parts,
Acetylene glycol (EO) adduct (manufactured by KAWAKEN FINE CHEMICALS KABUSHIKI KAISHA) 0.5 parts,
Deionized water balance.

### Yellow Ink

### (1) Dispersion Liquid Preparation

First, the anionic polymer P-1 was neutralized with an aqueous solution of potassium hydroxide, followed by dilution with deionized water, thereby preparing 10% by mass of homogeneous aqueous polymer solution.

Three hundred grams of the polymer solution, 100 g of C.I. Pigment Yellow 74, and 600 g of deionized water were mixed and mechanically agitated for a predetermined time, followed by centrifugal separation to remove undispersed substances including coarse particles, thereby obtaining a yellow dispersion liquid. The obtained yellow dispersion liquid had a pigment concentration of 10% by mass.

### (2) Ink Preparation

Components specified below were mixed and sufficiently agitated to dissolve and disperse the components, followed by pressure filtration using a microfilter (manufactured by FUJI FILM KABUSHIKI KAISHA) having a pore size of 1.0 μm, thereby preparing a pigment ink having a pigment concentration of 3% by mass.
The yellow dispersion liquid 30 parts,
The resin particle dispersion liquid 40 parts,
Wax particles 3 parts,
Zonyl FSO-100 (fluorinated surfactant manufactured by DuPont) 0.025 parts,
2-Methyl-1,3-propanediol 15 parts,
2-Pyrrolidone 5 parts,
Acetylene glycol (EO) adduct (manufactured by KAWAKEN FINE CHEMICALS KABUSHIKI KAISHA) 1 part
Deionized water balance.

### Clear Ink

Components specified below were added to adjust the clear ink in the present embodiment to a predetermined concentration. Subsequently, these components were sufficiently mixed and agitated, followed by pressure filtration using a microfilter (manufactured by FUJI FILM KABUSHIKI KAISHA) having a pore size of 2.5 μm, thereby preparing a clear ink having a resin particle concentration of 12% by mass.
The resin particle dispersion liquid 60 parts
Wax particles 3 parts
Zonyl FSO-100 (fluorinated surfactant manufactured by DuPont) 0.05 parts
2-Methyl-1,3-propanediol 15 parts
2-Pyrrolidone 5 parts
Acetylene glycol (EO) adduct (manufactured by KAWAKEN FINE CHEMICALS KABUSHIKI KAISHA) 0.5 parts
Deionized water balance.

### Processing Liquid

Each processing liquid used in the present embodiment contains a reagent that reacts with a pigment contained in an ink and induces aggregation or gelation of the pigment. In the present embodiment, a polyvalent metal salt, specifically magnesium sulfate heptahydrate, was used as the reagent.

It can be noted that magnesium sulfate heptahydrate does not necessarily have to be used, and in the present embodiment, various organic acids that are soluble in water and polyvalent metal salts can be used as the reagent in the processing liquid. The content of organic acid or polyvalent metal salt can be higher than or equal to 0.1% by mass and lower than or equal to 90.0% by mass, or higher than or equal to 1.0% by mass and lower than or equal to 70.0% by mass, based on the total mass of the compositions contained in the processing liquid.

It can be noted that magnesium sulfate does not necessarily have to be used, and in the present embodiment, various organic acids that are soluble in water and polyvalent metal salts can be used as the reactive component of the processing liquid.

The organic acid or polyvalent metal salt content can be higher than or equal to 0.1% by mass and lower than or equal to 90.0% by mass, or higher than or equal to 1.0% by mass and lower than or equal to 70.0% by mass, based on the total mass of the compositions contained in the processing liquid.

### (1) Processing Liquid Preparation

In the present embodiment, as described above, magnesium sulfate heptahydrate was used, and components specified below were mixed, thereby preparing a processing liquid.
Magnesium sulfate heptahydrate 4 parts
1,2-Butanediol 10 parts
Acetylene glycol (EO) adduct 0.5 parts
Deionized water (manufactured by KAWAKEN FINE CHEMICALS KABUSHIKI KAISHA) balance.

### Evaluation Method

### Abrasion Resistance

Abrasion resistance evaluations and evaluation standards after image recording in the present embodiment will be described.

An evaluation machine conforming to a friction tester type II (Japan Society for the Promotion of Science type) defined in a method for testing color fastness to rubbing (JIS L-0849), which is also commonly used in “friction and wear resistance tests” of inks. A test specimen that had been prepared by recording solid images by applying different amounts of black ink on a polyvinyl chloride sheet and heating and fixing the solid images was bonded to a curved surface, and a white cotton cloth fixed to a rubbing element was rubbed back and forth against the test specimen 150 times. Then, the degree of transfer to the cloth and the degree of abrasion of the recorded image regions were evaluated by visual observation.

### Color Ink Processing Liquid Application Amount Setting

A specific method for determining processing liquid and clear ink application amounts that are suitable for performing the image recording method according to the present embodiment will be described.

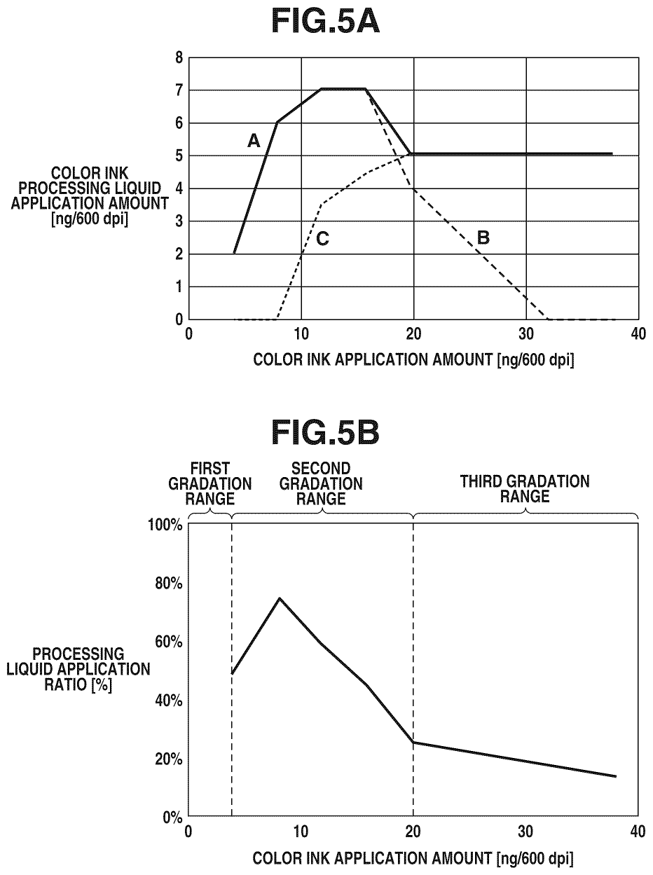

First, color ink processing liquid data generation processing in which information about the processing liquid applied to each predetermined region of a recording medium is determined based on information about the color ink application amount will be described. In FIG. 5A, line A illustrates the content of the processing liquid data lookup table used in step S404 in the processing liquid image data generation processing according to the present embodiment for a recorded material obtained by performing recording on a polyvinyl chloride sheet IJ1220-10 (3M JAPAN KABUSHIKI KAISHA) using the inkjet recording apparatus 100 according to the first embodiment. Further, FIG. 5B illustrates the relationship between the color ink application amount and the ratio of the processing liquid application amount to the color ink application amount applied per pixel in a case where the lookup table illustrated in FIG. 5A is used. The term “color ink application amount” herein refers to the sum of the application amounts of the color inks applied to each predetermined region of a recording medium. The control system illustrated in FIG. 3 controls the processing liquid application amount in accordance with the color ink application amount based on the above-described relationship. It can be noted that the optimal relationship between the color ink application amount and the processing liquid application amount varies depending on the recording medium, recording mode, or the like. Accordingly, a plurality of tables for different recording modes is normally stored in advance in the ROM 302, and the control unit is configured to perform processing by referring to an appropriate lookup table for the set recording mode. The tables storing the relationship between the color ink application amount and the processing liquid application amount are determined in consideration of recorded image granularity and prevention of bleeding for each recording condition. Details thereof will be described.

In general, an increase in granularity can be prevented by applying the similar amount of the processing liquid as the amount of the color inks to a halftone region where a change in granularity of the recorded image occurs frequently due to adjacency of ink dots. In this case, processing liquid dots can be applied to overlap color ink dots. In a low-gradation range where the total color ink duty is less than the total color ink duty in the above-described gradation range, the probability of adjacent dot presence is low without applying as much processing liquid as in the halftone region, so that an increase in granularity is less likely to occur. Line B in FIG. 5A illustrates a table storing the relationship between the color ink application amount and the color ink processing liquid application amount that is necessary in consideration of granularity in a case where recording is performed on a polyvinyl chloride sheet IJ1220-10 using the inkjet recording apparatus 100 according to the first embodiment.

The above-described table storing the processing liquid application amount that is necessary to prevent an increase in granularity is acquired by using patterns for detecting a granularity state and reading a recorded image with an image scanner. The optimal processing liquid amount for the color ink amount is calculated using an assessment image where patterns for applying predetermined amounts of the color inks and the processing liquid to predetermined regions are arranged. As an example of a granularity evaluation method, Graininess (defined in International Organization for Standardization (ISO) 13660) as an evaluation measure of the granularity of a solid image was used. Further, a Scotchcal Graphic Film IJ1220N (gloss finish, 3M JAPAN KABUSHIKI KAISHA), which is an inkjet recording medium for use in outdoor signate, was used. Image reading is performed in decreasing order of processing liquid amount, starting with the pattern having the greatest processing liquid amount, among the patterns with different processing liquid amounts for different color ink amounts on the assessment image, and the necessary processing liquid is determined based on the assumption that the processing liquid amount immediately before a change in granularity is greater than or equal to a predetermined amount is the condition for the minimum processing liquid amount that does not cause image impairment.

On the other hand, a gradation range where the total color ink duty is greater than the total color ink duty in the halftone region requires the processing liquid to prevent bleeding in an adjacent color region. In this gradation range, color dots overlap and form an ink film, so that the need to apply the processing liquid to reduce granularity decreases. Further, the processing liquid application amount can be minimized from the perspective of ink cost and increased drying load. Line C in FIG. 5A illustrates a table storing the relationship between the color ink application amount and the color ink processing liquid application amount that is necessary in consideration of bleeding performance in a case where recording is performed on a polyvinyl chloride sheet IJ1220-10 using the inkjet recording apparatus 100 according to the first embodiment.

The above-described table storing the processing liquid application amount that is necessary to prevent bleeding is acquired by using patterns for detecting a bleeding state, detecting a change in output values of an optical sensor, and evaluating the clarity of a boundary portion. The processing liquid is applied to the entire pattern with a first color ink applied as a background color to a predetermined region and a second color ink applied as a thin line color to an adjacent region. This pattern for each color ink amount and predetermined processing liquid amount is arranged on an assessment image, and using this assessment image, the optimal processing liquid amount for the color ink amount with respect to the predetermined combination of the first color ink and the second color ink is calculated. In such a pattern, a change in optical sensor output increases when a bleeding phenomenon occurs. Output value reading is performed in decreasing order of processing liquid amount, starting with the pattern having the greatest processing liquid amount, among the patterns with different processing liquid amounts for different color ink amounts on the assessment image, and the necessary processing liquid is determined based on the assumption that the processing liquid amount immediately before a change in the output value is greater than or equal to a predetermined amount is the condition for the minimum processing liquid amount that does not cause image impairment.

The recorded assessment image is read, and the results need to be provided as feedback to the control unit. As reading units, a measuring apparatus for granularity evaluation and a bleeding measuring apparatus may be provided to the main unit and configured to automatically perform processing. However, in reality, providing such a configuration to the main unit leads to an excessive apparatus size. Accordingly, in general, a configuration in which the assessments described above are conducted using an external measuring apparatus or by the user through visual inspection and the assessment results are provided as feedback from a panel, a host, or the like to the control unit of the main unit is advantageous in terms of cost, configuration, and the like.

The table storing the relationship between the color ink application amount and the color ink processing liquid application amount used in the present embodiment is as illustrated by line A in FIG. 5A, based on the findings described above. The processing liquid application amounts for boundaries between the halftone region, the higher gradation range than the halftone region, and the lower gradation range than the halftone region are set in consideration of image continuity so that a continuous image is achieved. A second gradation range in FIG. 5B illustrates an example of the halftone region, and this range includes the maximum possible value of the ratio of the color ink processing liquid application amount to the color ink application amount. Further, a first gradation range is set on the lower gradation side, in which the sum of the application amounts of the color inks is less than that in the second gradation range, and a third gradation range is set on the higher gradation side in which the sum of the application amounts of the color inks is greater than that in the second gradation range. It can be noted that the halftone reference value (the color ink application amount) used as an indicator for selecting the processing liquid ejection control described above varies depending on the types of inks, processing liquid, and recording medium that are used, and can be selected within the range of 4 ng to 20 ng/600 dpi, as appropriate for the types of inks, processing liquid, and recording medium.

### Clear Ink and Clear Ink Processing Liquid Application Amount Setting

A specific method for determining clear ink and clear ink processing liquid application amounts that are suitable for performing the image recording method according to the present embodiment will be described.

As a result of determining the color ink processing liquid application amount to the color ink application amount in consideration of recorded image granularity and bleeding performance as described above, there is a gradation range, such as the second gradation range, where the ratio of the color ink processing liquid application amount to the color ink application amount is high due to gradation. It is known that in such a range, the abrasion resistance of the recorded image decreases compared to other gradations. Accordingly, in the present embodiment, the clear ink application amount for the second gradation range is controlled to be greater than the clear ink application amounts for the first and third gradation ranges.

The clear ink and clear ink processing liquid data generation processing performed in step S404 to determine information about the clear ink applied to each predetermined region of the recording medium based on the color ink and processing liquid application amounts will be described.

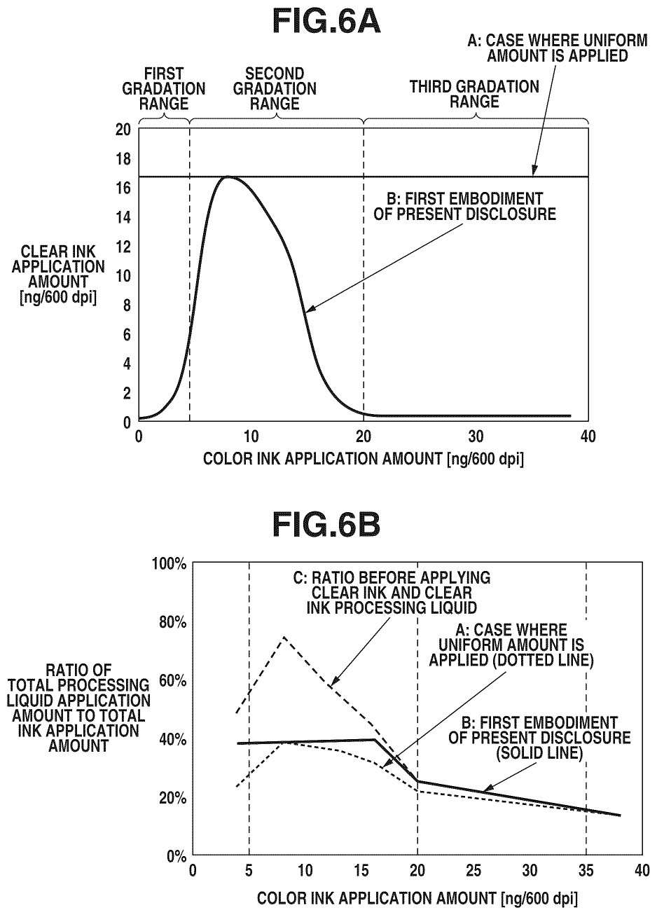

FIG. 6A is a diagram illustrating the content of examples of a clear ink data lookup table and a clear ink processing liquid data lookup table used in the clear ink and clear ink processing liquid data generation processing in step S404 in the present embodiment. In the data generation processing, the clear ink and clear ink processing liquid application amounts are set based on the relationship between the color ink application amount and the color ink processing liquid application amount for each predetermined region of the recording medium. According to experiments conducted by the present inventors, it is known that sufficient abrasion resistance can be obtained in a case where the ratio of the total processing liquid application amount, which is the sum of the application amount of the color ink processing liquid and the application amount of the clear ink processing liquid, to the total ink application amount, which is the sum of the application amounts of the color and clear inks applied to each predetermined region of the recording medium, is 40% or less. Line B in FIG. 6A illustrates an example of a table in a case where all recording gradations are controlled to achieve 40% or less, and line A in FIG. 6A illustrates an example of a table in a case where the clear ink is uniformly applied at a rate of 18 ng/600 dpi regardless of the gradation, which differs from the control according to the present embodiment. Line B in FIG. 6A is determined so that the maximum clear ink application amount, among the clear ink application amounts that may be determined for each recording gradation of the color ink based on the table described above, is included in the second region. The control system illustrated in FIG. 3 controls the clear ink application amount in accordance with the color ink application amount based on the relationship described above. The table does not necessarily have to be as described above but can be configured so that the processing liquid and clear ink application amounts are continuous with respect to the color ink application amount, as in the table described above. Further, a table configured so that the ratio of the clear ink application amount to the clear ink processing liquid application amount is 15%, which is equal to the ratio of the color ink processing liquid application amount to the color ink application amount in the third gradation range. However, the ratio does not necessarily have to be set as described above.

FIG. 6B illustrates the relationship between the color ink application amount for each predetermined region of the recording medium and the ratio of the total processing liquid application amount, which is the sum of the color ink processing liquid application amount and the clear ink processing liquid application amount, to the total ink application amount, which is the sum of the color ink application amount and the clear ink application amount. Line A in FIG. 6A illustrates the ratio of the total processing liquid application amount to the total ink application amount in a case where the table is used to uniformly apply the clear ink at a rate of 18 ng/600 dpi regardless of the gradation. Line B in FIG. 6A illustrates the ratio of the total processing liquid application amount to the total ink application amount in a case where the table is used to control all recording gradations to achieve 40% or less. Line C in FIG. 6A illustrates the ratio of the color ink processing liquid application amount to the color ink application amount illustrated in FIG. 5B.

The clear ink and the clear ink processing liquid were applied using the table illustrated by line A in FIG. 6A to uniformly apply the clear ink at a rate of 18 ng/600 dpi regardless of the gradation. In this case, the second gradation range of the recorded image exhibited excellent abrasion resistance, compared to the case where only the color inks and the color ink processing liquid were applied. However, no significant improvements were observed in the first and third gradation ranges. This is considered to be due to the following reasons. In the second gradation range, the abrasion resistance had been low due to the high ratio of the color ink processing liquid application amount to the color ink application amount, and applying the clear ink decreased the ratio. As a result, the abrasion resistance improved. In the first and third gradation ranges, on the other hand, the ratio of the color ink processing liquid application amount to the color ink application amount is less than that in the second gradation range. Therefore, applying the clear ink has no significant effect on improving the abrasion resistance. This indicates that the clear ink and the clear ink processing liquid are excessively applied in the first and third gradation ranges, which is not desirable from the perspective of drying load and ink cost.

The clear ink was applied using the table illustrated by line B in FIG. 6A. In this case, the abrasion resistance evaluation result of the second gradation range was excellent, as in the case where the table illustrated by line A in FIG. 6A was used. Further, in the first and third gradation ranges, although the clear ink and clear ink processing liquid application amounts were less than those in the case where the table illustrated by line A in FIG. 6A was used, there was no difference in abrasion resistance evaluation results.

By controlling the clear ink and clear ink processing liquid application amounts as in the present embodiment, both image quality performance of the recorded image, including reduced granularity and bleeding, and improved abrasion resistance can be achieved while reducing the amounts of the clear ink and processing liquid used.

### Second Embodiment

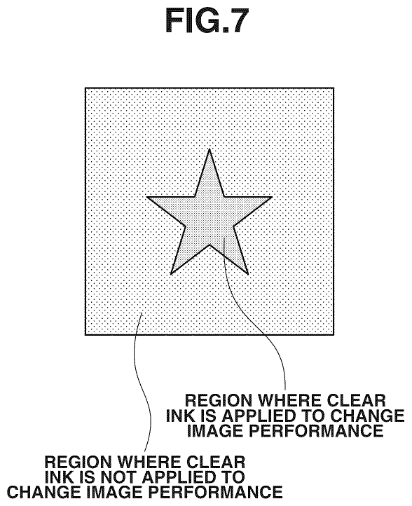

The present embodiment describes a control method in a case where the clear ink is applied to change the image performance. The phrase “to change the image performance” refers to, for example, changing the weather resistance, water resistance, alkali resistance, glossiness, haze characteristic, or bronze characteristic of the image, changing the unevenness of the image surface, or the like. FIG. 7 illustrates image data indicating that the inside of the star shape is a region where the clear ink is applied to change the image performance, and that the outside of the star shape is a region where the clear ink is not applied to change the image performance.

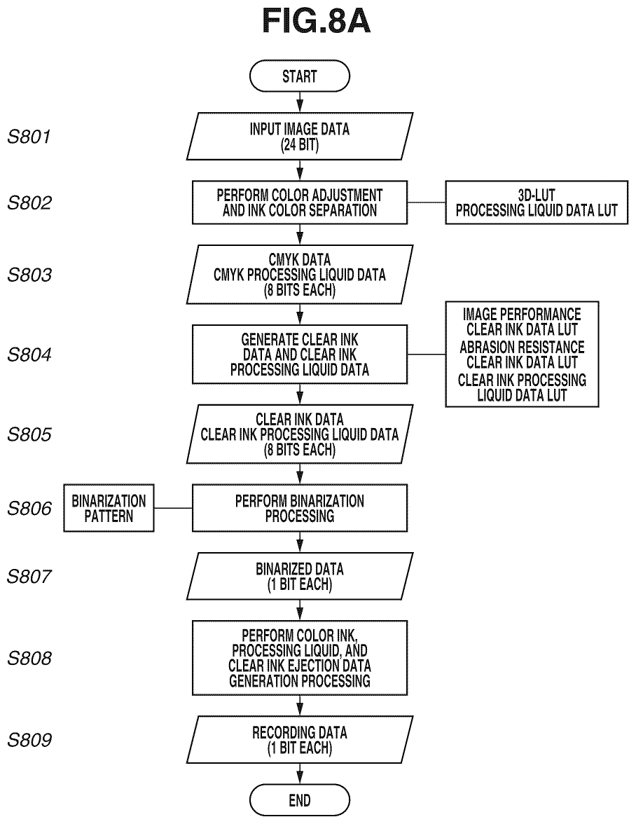

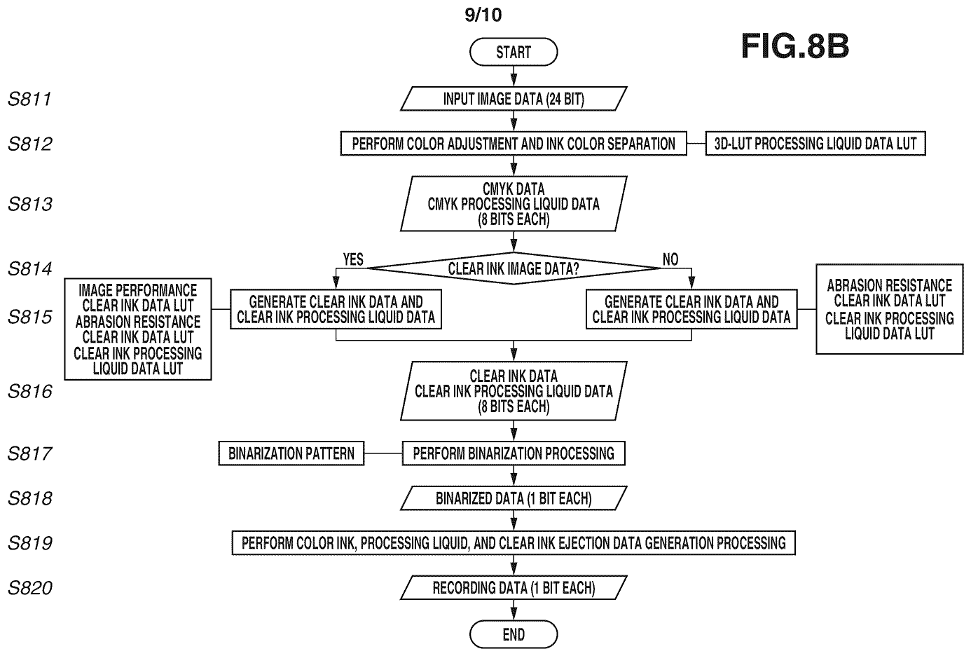

FIG. 8A illustrates a data processing flow according to the second embodiment. The clear ink data lookup table and the clear ink processing liquid data lookup table illustrated in FIG. 6A and used in the first embodiment will be referred to as an “abrasion resistance clear ink data table” and an “abrasion resistance clear ink processing liquid data table”, respectively, and a clear ink data lookup table and a clear ink processing liquid data lookup table used in the present embodiment to determine the amount of the clear ink applied to change the image performance will be referred to as an “image performance clear ink data table” and an “image performance clear ink processing liquid data table”, respectively, to distinguish the tables.

An example of the “image performance clear ink data table” used in the clear ink ejection data generation processing in step S805 in the present embodiment will be described. In the present embodiment, a table configured so that the clear ink is uniformly applied at a rate of 80 ng/600 dpi in the region where the clear ink is determined to be applied, regardless of the color ink application amount, is used. Further, at this time, a table configured so that the clear ink processing liquid application amount equals 15% of the clear ink application amount is used as the “image performance clear ink processing liquid data table”.

In step S804, each application amount is set for each predetermined region of the recording medium based on the input image data using a table storing, for each recording medium type, the relationship between the clear ink and clear ink processing liquid application amounts and the color ink application amount, and 8-bit image data corresponding to the application amounts is generated. At this time, the greater of the clear ink application amounts set based on the “abrasion resistance clear ink data table” and the “image performance clear ink data table” is selected. Further, in a case where the clear ink application amount based on the “abrasion resistance clear ink data table” is selected, the clear ink processing liquid application amount based on the “abrasion resistance clear ink processing liquid data table” is selected, and in a case where the clear ink application amount based on the “image performance clear ink data table” is selected, the clear ink processing liquid application amount based on the “image performance clear ink processing liquid data table” is selected.

By performing the above-described control, the clear ink is applied in an amount greater than or equal to the clear ink application amount based on the relationship stored in the “abrasion resistance clear ink data table” in the second gradation range where the abrasion resistance can decrease easily in a case where the clear ink is not applied. This makes it difficult for a decrease in abrasion resistance to occur. On the other hand, in a case where the clear ink is applied for a purpose other than improvement in abrasion resistance, the application of the clear ink is controlled to prevent further application of the clear ink to improve abrasion resistance. This makes it possible to prevent excessive use of the clear ink.

It can be noted that information for determining whether to apply the clear ink may be provided by the image input by the user or by data processing based on the image input by the user. In this case, the control is performed by the data processing flow illustrated in FIG. 8B. At this time, the clear ink and clear ink processing liquid application amounts for a region where clear ink data for changing the image performance is determined to be present by the determination processing in step S814 are set based on the “image performance clear ink data table” and the “image performance clear ink processing liquid data table”, and the clear ink and clear ink processing liquid application amounts for a region where clear ink data for changing the image performance is determined to be absent are set using the “abrasion resistance clear ink data table” and the “abrasion resistance clear ink processing liquid data table” preferentially.

Instead of the application method in which both tables are referred to and the greater application amount is used as in the present embodiment, another method may be employed in which it is determined, for each predetermined region, whether the clear ink is to be applied to change the image performance and the similar control as in the first embodiment is performed only on a region where it is determined that the clear ink is not applied to change the image performance.

### Third Embodiment

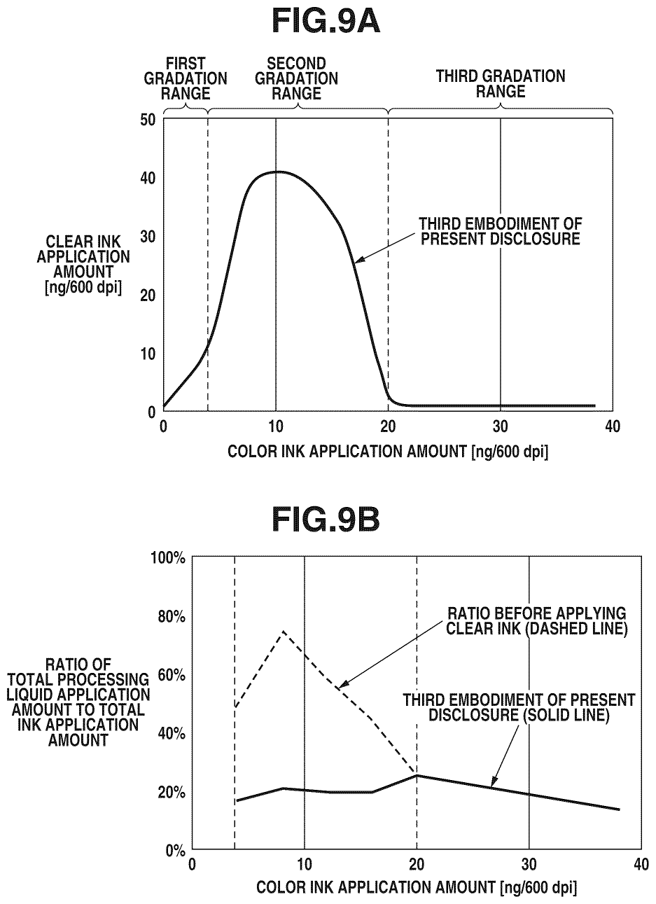

In the present embodiment, the ratio of the total processing liquid application amount to the total ink application amount in the second gradation range is controlled to be less than the ratio of the total processing liquid application amount to the total ink application amount in the third gradation range. FIGS. 9A and 9B are diagrams illustrating the present embodiment. The present embodiment is similar to the first embodiment, except for the clear ink ejection data generation processing for determining the clear ink application amount for each predetermined region of the recording medium and the clear ink processing liquid ejection data generation processing for determining the clear ink processing liquid application amount. A control method according to the third embodiment will be described.

FIG. 9A is a diagram illustrating the content of a clear ink ejection data lookup table used in the clear ink ejection data generation processing in the present embodiment for an image recorded by an inkjet recording apparatus according to the third embodiment. At this time, the table configured so that the clear ink processing liquid application amount equals 15% of the clear ink application amount is used, as in the first embodiment. Further, FIG. 9B illustrates the relationship between the color ink application amount and the ratio of the total processing liquid application amount, which is the sum of the color ink processing liquid application amount and the clear ink processing liquid application amount, to the total ink application amount, which is the sum of the amounts of the color and clear inks applied per pixel of the recording medium, in a case where the clear ink and the clear ink processing liquid are applied using the lookup table illustrated in FIG. 9A.

The lookup table illustrated in FIG. 9A is configured so that for each pixel of the recording medium, the ratio of the total processing liquid application amount to the total ink application amount in the second gradation range becomes less than or equal to the ratio of the total processing liquid application amount to the total ink application amount in the third gradation range.

Controlling the clear ink and clear ink processing liquid application amounts as described above makes it possible to improve the abrasion resistance in the second gradation range to be equivalent to the abrasion resistance in the third gradation range. Since the ratio of the processing liquid application amount to the total ink application amount in the second gradation range is decreased to be less than or equal to that in the third gradation range, a decrease in the abrasion resistance is prevented.

Applying the clear ink and the clear ink processing liquid based on the relationship between the color ink and processing liquid application amounts for each predetermined region of the recording medium as in the present embodiment makes it possible to improve the abrasion resistance of the recorded image across the entire gradation range, although the consumption of the clear ink increases, compared to the first embodiment.

### Other Embodiments

Applicable inks are not limited to the compositions described above. Further, as the color inks, a dye ink or a pigment ink or both can be used. Further, for example, in a case where a plurality of processing liquids each having a different reagent concentration is used, it is still possible to perform the similar control as in the present embodiment, by changing the calculated value of the ratio to the ink application amount based on the reagent concentration. As the clear ink, a liquid having various functions can be used, or a semi-transparent ink may be used.

Further, for example, a so-called full-line type recording method using a long recording head extending along the width direction of the recording medium may be used.

In the above-described embodiments, the clear ink amount in the halftone range (where the reactive liquid/color value is higher than the high gradation) can be greater than the clear ink amount in the high gradation range (where the reactive liquid/color value is lower than the halftone) and greater than the clear ink amount in the low gradation range (where the reactive liquid/color value is lower than the halftone).

According to the above-described embodiments, the necessary amount of the clear ink is applied to the necessary region in the recording gradation range where the ratio of the processing liquid applied to the total ink amount applied per unit region often increases and a decrease in abrasion resistance can occur easily. This makes it possible to prevent a decrease in abrasion resistance while reducing the clear ink application amount, thereby obtaining a recorded image with high fastness across the entire gradation range.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-159228, filed Sep. 13, 2024, and No. 2025-141029, filed Aug. 27, 2025, which are hereby incorporated by reference herein in their entirety.

What is claimed is:

1. A recording apparatus comprising:
a recording unit including a plurality of ejection ports configured to apply a color ink containing a resin particle and a color material, a plurality of ejection ports configured to apply a clear ink containing a resin particle but not containing a color material, and a plurality of ejection ports configured to apply a processing liquid containing a reactive component that reacts with the resin particle and the color material in the color ink and with the resin particle in the clear ink and induces aggregation or gelation; and
a determination unit configured to determine an application amount of the color ink, an application amount of the clear ink, and an application amount of the processing liquid that are applied from the recording unit per unit region of a recording medium,
wherein the determination unit determines the application amount of the clear ink and the application amount of the processing liquid for at least three gradations each having an application amount ratio of the application amount of the processing liquid to the application amount of the color ink, each application amount ratio being different from each other,
wherein the application amount of the clear ink for a second gradation range in which the application amount of the color ink is a second amount and the application amount ratio is a second ratio, is greater than the application amount of the clear ink for a first gradation range in which the application amount of the color ink is a first amount less than the second amount and the application amount ratio is a first ratio less than the second ratio, and
wherein the application amount of the clear ink for the second gradation range in which the application amount of the color ink is the second amount, is greater than the application amount of the clear ink for a third gradation range in which the application amount of the color ink is a third amount greater than the second amount and the application amount ratio is a third ratio less than the second ratio.

2. The recording apparatus according to claim 1, wherein the determination unit includes an assessment image for granularity assessment of a recorded image in which an application amount ratio of the color ink and the processing liquid is changed, and determines the application amount of the processing liquid to the application amount of the color ink for the second gradation range based on the assessment image for granularity assessment.

3. The recording apparatus according to claim 1, further comprising an acquisition unit configured to acquire assessment image data for clarity assessment of a boundary portion in which an application amount ratio of the color ink and the processing liquid is changed,
wherein the determination unit determines the application amount of the processing liquid to the application amount of the color ink for the third gradation range based on the assessment image data.

4. The recording apparatus according to claim 1, further comprising a second determination unit,
wherein the greater of application amounts determined by the first determination unit and the second determination unit is selected as the application amount of the clear ink.

5. The recording apparatus according to claim 4, wherein, in a case where the application amount of the clear ink determined by the second determination unit is selected, priority is given to the application amount of the clear ink determined by the second determination unit.

6. The recording apparatus according to claim 1, wherein the determination unit determines the application amount of the color ink, the application amount of the clear ink, and the application amount of the processing liquid such that a ratio of the application amount of the processing liquid to a sum of the application amount of the color ink and the application amount of the clear ink for the first gradation range is less than or equal to a ratio of the application amount of the processing liquid to a sum of the application amount of the color ink and the application amount of the clear ink for the third gradation range.

7. The recording apparatus according to claim 1, wherein an amount of ink transferred to the recording medium during a one-second transfer time is less than or equal to 20 ml/m2, as measured by a Bristow method.
